(19) United States
(12) Patent Application Publication
(10) Pub. No.: US 2014/0235761 A1
(43) Pub. Date: Aug. 21, 2014

(54) COMPOSITION FOR BIOMASS FILM USING FOOD BYPRODUCT OF WHEAT BRAN OR SOYBEAN HULL AND BIOMASS FILM USING THE SAME

(71) Applicants: CJ CHEILJEDANG CORPORATION, Seoul (KR); AU CO., LTD., Gyeonggi-do (KR)

(72) Inventors: Chan Suk YOON, Seoul (KR); Jung Gu HAN, Incheon (KR); Young Sun YOU, Seoul (KR)

(73) Assignees: AU CO., LTD., Gyeonggi-do (KR); CJ CHEILJEDANG CORPORATION, Seoul (KR)

(21) Appl. No.: 13/866,729

(22) Filed: Apr. 19, 2013

(30) Foreign Application Priority Data
Feb. 21, 2013 (KR) 1020130018506

(51) Int. Cl. C09D 189/04

(52) U.S. Cl. CPC C09D 189/04
USPC 524/15

(57) ABSTRACT

A composition for a biomass film using a food byproduct including wheat bran or soybean hull and to a biomass film using the same and, more particularly, to a biomass film which is improved in processability, has high water resistance, oil resistance and pinhole resistance so as to be adapted for shopping bags, exhibits carbon reduction properties by use of a carbon neutral type plant food byproduct, and is increased in terms of degradability upon natural reclamation. The composition includes 100 parts by weight of a polyolefin-based resin, 50˜150 parts by weight of a powdery porous grassy biomass comprising one or more selected from the group consisting of wheat bran and soybean hull, 5˜20 parts by weight of an inorganic filler, 0.5˜3 parts by weight of a surface coating agent, and 1˜10 parts by weight of a liquid low-molecular-weight compound.

### CROSS-REFERENCE TO RELATED APPLICATIONS

This application claims the benefit of Korean Application No. 10-2013-0018506 filed Feb. 21, 2013, in the Korean Intellectual Property Office, the disclosure of which is incorporated herein by reference.

### BACKGROUND OF THE INVENTION

1. Field of the Invention

The present invention relates to a composition for a biomass film using a food byproduct including wheat bran or soybean hull and to a biomass film using the same and, more particularly, to a biomass film, which is improved in processability, has high water resistance, oil resistance and pinhole resistance so as to be adapted for use in shopping bags, exhibits carbon reduction properties by use of a carbon neutral type plant food byproduct, and is increased in terms of degradability upon natural reclamation.

2. Description of the Related Art

Examples of plastic films mainly used in packaging include polyvinyl chloride (PVC), polyethylene (PE), polypropylene (PP), nylon, polyethyleneterephthalate (PET), etc. Among them, PVC generates harmful materials such as dioxin upon incineration, and polypropylene, nylon, PET, etc., have a comparatively stable molecular structure and thus exhibit good mechanical properties. However, when such plastic films are buried underground without any specific treatment after having been used for packaging, they barely degrade because of their chemical and biological stability, causing them to accumulate in land, undesirably shortening the lifetime of landfill and incurring soil pollution.

Bioplastics have functions (strength, water resistance, formability, heat resistance, etc.) similar to those of general plastics during usage. Bioplastics refers to plastics which are eventually decomposed into water, carbon dioxide and biomass via a procedure of converting a high-molecular-weight compound into a low-molecular-weight compound by virtue of activities of microoragnisms in a natural environment.

Examples of bioplastics, which are currently available as plastic alternatives based on the concept of carbon reduction and oxo-biodegradation using biomass, include (1) carbon reducible bioplastics obtained by mixing plants such as carbon neutral type biomass kenaf, rice straw, wheat straw, rice hulls, wheat brans, bean husks, corn husks, corn stalks, corn cores, plant stem powder, starch, etc. with general plastics or biodegradable plastics, (2) carbon reducible polymer composites obtained by mixing developed biodegradable plastics such as PLA. PCL, etc. with general plastics, (3) polylactides synthesized via a ring opening reaction using an enzymatic chemical catalyst from lactic acid or lactide, (4) ε-caprolactone and other diol-diacid based aliphatic polyesters, (5) natural materials obtained by mixing rice straw, wheat stalks, sawdust, waste pulp, etc. with acrylic resin and starch and then compacting the mixture, (6) celluloses synthesized by treating paper, pulp, etc. with acetic acid, and (7) oxo-biodegradable products using carbon reducible plant biomass, general plastics, biodegradable resin, a decomposition accelerator, an oxidant, a compatibilizer, biodegradable plastics, etc. Bio-based plastics may be recycled and are degradable when buried underground, do not discharge harmful materials such as dioxin upon incineration, have a heat value of 4000˜7000 kcal, which is much lower than that of general plastics, and may reduce a risk of damaging an incinerator.

Currently, thorough research and development into polylactic acid as an aliphatic polyester having high biodegradability is ongoing. Although polylactic acid films derived from biomass are stable in terms of mechanical properties and transparency, they have low flexibility due to high crystallinity caused by a molecular structure thereof and are thus limited in applications to packaging or shopping bags. To solve these problems, a polyol plasticizer is used, but has a low molecular weight and thus may evaporate upon extrusion, undesirably resulting in poor flexibility. Upon extrusion, such films are problematic because it is difficult to form a sheet and heat resistance may decrease.

The case where products such as shopping bags are manufactured using a polyolefin-based resin is disadvantageous because rigidity is poor, and processability may deteriorate owing to materials used to solve rigidity problems. Particularly, the use of a biomass material to satisfy the demand for eco-friendly products may further exacerbate the above problems.

Meanwhile, in the case of biomass plastics and films obtained by using powder of primary agricultural waste, for example, wheat husk and bean hull, generated from food processes, processability may considerably decrease due to generation of moisture and gas upon processing. Especially, generation of carbides makes it impossible to perform continuous works. Furthermore, such biomass plastics and films may have lower water resistance, oil resistance, and gas barrier properties, compared to conventional plastic films, and thus the overall properties thereof have to be improved.

### SUMMARY OF THE INVENTION

Accordingly, the present invention has been keeping in mind the above problems occurring in the related art, and an object of the present invention is to provide a biomass film, which, despite using a food byproduct including wheat bran or soybean hull (porous grassy biomass), may have high processability to thus ensure properties suitable for forming a film, and may exhibit high biodegradability, and high compatibility with a typical olefin-based resin, resulting in high reproducibility and recyclability.

In order to accomplish the above object, the present invention provides a composition for a biomass film, comprising 100 parts by weight of a polyolefin-based resin, 50˜150 parts by weight of a powdery porous grassy biomass comprising one or more selected from the group consisting of wheat bran and soybean hull, 5˜20 parts by weight of an inorganic filler, 0.5˜3 parts by weight of a surface coating agent, and 1˜10 parts by weight of a liquid low-molecular-weight compound.

The pores of the powdery porous grassy biomass may be impregnated with the inorganic filler and the liquid low-molecular-weight compound. Also, the composition may further comprise 1˜10 parts by weight of a compatibilizer and 1˜10 parts by weight of a lubricant for plastics, in order to improve miscibility of the polyolefin-based resin and the powdery porous grassy biomass. The liquid low-molecular-weight compound may be one or more selected from the group consisting of MEG, DEG, TEG, and PEG.

The polyolefin-based resin may be PE, and the PE resin may comprise HDPE and at least one of LDPE, LLDPE or a combination thereof, wherein the HDPE is used in an amount of 60˜80 wt %, and at least one of the LDPE, the LLDPE or the combination thereof are used in an amount of 20˜40 wt %, based on a total weight of the PE resin.

Furthermore, the PE resin comprises HDPE, LDPE and LLDPE, wherein the HDPE is used in an amount of 60˜80 wt %, and the LDPE and the LLDPE are used in an amount of 20˜40 wt %, based on a total weight of the PE resin, wherein the LDPE is used in an amount of 15˜25 wt %, and the LLDPE is used in an amount of 75˜85 wt %, based on a total weight of the LDPE and the LLDPE.

The powdery porous grassy biomass may be processed from wheat bran.

In addition, the present invention provides a biomass film, composed mainly of the above composition and being reproducible and recyclable. The biomass film may be manufactured from only the above composition. In this case, a resin selected from the group consisting of EVA and SEBS may be further added, followed by performing extrusion, thereby enhancing elongation and tensile strength.

In addition, the present invention provides a method of manufacturing a biomass film which is reproducible and recyclable, comprising i) mixing a powdery porous grassy biomass comprising one or more selected from the group consisting of wheat bran and soybean hull, an inorganic filler, a surface coating agent, and a liquid low-molecular-weight compound, and heating them while being kneaded at a high speed, thus obtaining a mixture; ii) heating the mixture obtained in i), a polyolefin-based resin, a compatibilizer, and a lubricant for plastics while being mixed together, thus obtaining a mixed composition; and iii) extruding the mixed composition, thus forming a film. As such, the composition may comprise 100 parts by weight of the polyolefin-based resin, 50˜150 parts by weight of the porous grassy biomass, 5˜20 parts by weight of the inorganic filler, 0.5˜3 parts by weight of the surface coating agent, 1˜10 parts by weight of the liquid low-molecular-weight compound, 1˜10 parts by weight of the compatibilizer, and 1˜10 parts by weight of the lubricant for plastics, and the heating may be performed at 70˜110° C.

### BRIEF DESCRIPTION OF THE DRAWINGS

The above and other objects, features and advantages of the present invention will be more clearly understood from the following detailed description taken in conjunction with the accompanying drawings, in which:

FIG. 1 illustrates a scanning electron microscope (SEM) image of wheat bran before pulverization;

FIG. 2 illustrates a photograph of a biomass film according to the present invention; and

FIG. 3 illustrates an enlarged photograph of FIG. 2.

### DETAILED DESCRIPTION OF THE EMBODIMENTS

The present invention pertains to a technique for preparing a composition for a film adapted for shopping bags, industrial packaging or food packaging, using a biomass material. To this end, in the case of a film resulting from a biomass material, processability is particularly regarded as being important, and other necessary properties, biodegradability and compatibility, are also important.

In the present invention, porous grassy agricultural waste is used as a biomass material. This is effective for recycling waste resources and improving biodegradability. The porous grassy agricultural waste may include the husks of grains, rice straw, corn stalks, barley stalks, etc., and mixtures thereof. Particularly, in the present invention, wheat bran (wheat husk or bran) and soybean hull (bean husk) are useful, which have comparatively large amounts of fibers, such as cellulose or hemicellulose, crude fibers, etc. Thus these materials are suitable as the biomass material for use in films for shopping bags, and wheat bran is particularly useful. The porous grassy agricultural waste refers to a porous grassy biomass in the present invention. The grassy agricultural waste may be lyophilized, pulverized using a ball mill, and further pulverized using an air jet mill, thus obtaining a porous powder having a particle size of ones of μm. This refers to a powdery porous grassy biomass. FIG. 1 is an SEM image of wheat bran. The powdery porous grassy biomass is basically natural, contains moisture and gas, and has low specific gravity, making it difficult to form a plastic film. Also, this biomass has a surface area lager by ones of times to thousands of times than that of a resin, and thus is rapidly cooled upon mixed compounding with a polymer and is not easily heated even when the temperature is increased up to a softening temperature of the resin to be compounded. This is because a porous natural material easily emits heat and thus rapidly cools, and also because the coefficient of friction is decreased due to low specific gravity upon kneading with a resin. In the present invention, an inorganic filler is used so that pores are impregnated therewith, thereby slightly increasing a specific gravity and simultaneously decreasing the generation of gas in the course of extrusion. Also, a surface coating agent is used to prevent re-absorption of moisture. Also, a liquid low-molecular-weight compound is additionally used to further improve the properties. Also, a powdery red alga extract may be added to improve the properties. The pores of the porous grassy agricultural waste are preferably impregnated with such components, and the biomass thus impregnated refers to an impregnated powdery porous biomass.

The impregnated powdery porous biomass is kneaded with a plastic resin, thus forming a composition for a biomass film. The plastic resin composition is composed of a polyolefin-based resin, preferably a PE resin, and more preferably LDPE or LLDPE. LLDPE may be used alone depending on the desired properties. PE has a melting index (MI) of about 2 to 60, and in the present invention PE having a MI of 5 to 40 is preferably used. This is because flowability should be improved upon forming a film. In a hot cylinder, the binding force of a natural material coupled with the resin may be weakened by frictional heat of a screw, etc., and thereby the residual natural material may be formed into carbides. These carbides are coated again with a resin having high flowability to function as a compatibilizer, thus stabilizing flow and dispersion, so that the extrusion temperature of the resin passed through a dice is made uniform, thereby enhancing thickness uniformity of the film and elongation stability.

The present invention provides a composition for a biomass film comprising 100 parts by weight of a polyolefin-based resin, 50˜150 parts by weight of a powdery porous grassy biomass, 5˜20 parts by weight of an inorganic filler, 0.5˜3 parts by weight of a surface coating agent, and 1˜10 parts by weight of a liquid low-molecular-weight compound. The composition may additionally include 1˜10 parts by weight of a powdery red alga extract so as to further improve the properties. The red alga extract may enhance the rigidity of a film during processing, and enables a product to be adapted for a shopping bag. In end uses for fertilizer sacks, this extract may be used in an amount larger than when used in a shopping bag.

The inorganic filler, which is deposited into the pores of the powdery grassy agricultural waste, may be any one or a mixture of two or more selected from the group consisting of calcium carbonate, glass fibers, talc, mica, quartzite, clay powder, wollastonite, talcum, kaolin powder, silica, mica, kaolin, and titanium dioxide. In order to improve the properties of the film, the inorganic filler is preferably provided in the form of a nano-sized powder in a predetermined amount. If the amount of the inorganic filler is too low, the extent of impregnation of the porous biomass is also low, so that the surface of the biomass is not sufficiently modified, and air is more likely to remain in the porous biomass, undesirably deteriorating the properties of the film due to generation of moisture and gas in the course of processing. In contrast, if the amount thereof is excessively large, the mechanical properties of the film may deteriorate.

The surface coating agent is used to coat the surface of the grassy agricultural waste so as to prevent re-absorption of moisture, and may be any one or a mixture of two or more selected from the group consisting of stearates, palmitates, and laurates. Preferably useful is calcium stearate, zinc stearate, or a mixture thereof. If the amount of the surface coating agent is too low, a coating is not sufficiently formed, making it impossible to prevent re-absorption of moisture onto the surface of powder. In contrast, if the amount thereof is excessively large, slippage between the polymer resin and the natural material upon extrusion may be caused, undesirably deteriorating mechanical properties. The surface coating agent has ingredients similar to those of a lubricant for plastics, as will be described later, but has functions different therefrom, and the term “lubricant for plastics” is separately used, and the process thereof is regarded as being important.

The liquid low-molecular-weight compound functions to improve properties of a film according to the present invention. The liquid low-molecular-weight material is a basic compound used upon synthesizing a polyolefin-based resin, and examples thereof may include glycols, such as MEG, DEG, TEG, etc., having a lower molecular weight of 1200 or less, which may be used alone or in combination of two or more, and the amount thereof may vary depending on the amount of the powdery porous biomass. As the pores are impregnated therewith, side effects due to gas or air which may be left behind in the pores may be minimized, and kneading with a plastic resin may be improved even at low temperature, thus increasing water resistance, oil resistance, and pinhole resistance. Especially, elongation of the film may be enhanced. If the amount of the liquid low-molecular-weight compound is too low, an effect on improving the above properties becomes insignificant. In contrast, if the amount thereof is excessively large, the remainder thereof may be carbonized and thermally oxidized, undesirably deteriorating mechanical properties of the film.

The powdery red alga extract may be additionally used to further improve the properties of the film according to the present invention. The red alga contains a large amount of fibrous material, and has superior thermal stability to that of typical cellulose. The red alga extract may be obtained from agar, Gigartina tenella, Irish moss, etc. Particularly, carrageenan, agarose, amylopectine, etc. are preferable. Carrageenan is a complex polysaccharide extracted from red algae, and may function as a dispersant, an emulsion stabilizer, a swelling agent, a thickening agent, a binding agent, dietary fibers, or a crystal forming inhibitor. Typically, carrageenan is an anion polymer having a sulfuric acid functional group with high hydrophilicity, and is classified into, depending on the amount and position of the sulfuric acid functional group, kappa-(κ-), lambda-(λ-), iota-(ι-), mu-(μ-), and κ-furcellarans, which may be used alone or in combination. Typically, three types of carrageenans, such as kappa-, lambda-, and iota-carrageenans, are mainly used. These carrageenans have a high ability to form a film. Also, agarose, etc., may have a sulfuric acid functional group and may thus function similarly to carrageenan. The red alga extract is preferably used in an amount of 1˜10 parts by weight per 100 parts by weight of the polyolefin-based resin used as the base resin. If the extract is used in too low an amount, it does not aid the ability to form a film. In contrast, if the extract is excessively used, mechanical properties may deteriorate.

As the pores are impregnated with such components, side effects due to gas or moisture which may be left behind in the pores may be minimized and kneading with a plastic resin may be improved, thus enhancing not only water resistance, oil resistance, and pinhole resistance, but also elongation of the film.

Specifically, the powdery porous grassy biomass, the inorganic filler, the surface coating agent, and the liquid low-molecular-weight compound are mixed and kneaded at a high speed, so that the pores are impregnated with predetermined materials and coated. The coating process is performed to prevent re-absorption of moisture. Upon kneading, heating is conducted in the rage from 70° C. to 110° C. for 10˜30 min, so that the inorganic filler-impregnated powdery grassy biomass is preferably coated. Subsequently, the impregnated powdery porous grassy biomass is mixed with a polyolefin-based resin. To improve miscibility of the resin and the powdery grassy biomass, 1˜10 parts by weight of a compatibilizer and 1˜10 parts by weight of a lubricant for plastics are preferably further added. Other necessary additives may be further added. Also, additives such as an anti-blocking agent, a cross-linking agent, an antioxidant, a thermal stabilizer, a UV absorber, a plasticizer, etc., may be added via a typical process, within a range that does not impede the effects of the invention.

Used in the present invention, the compatibilizer functions to compatibilize the non-polar synthetic resin and the polar grassy agricultural waste, without being separated from each other, and examples thereof include glycidyl methacrylate, ethylene vinyl alcohol, polyvinyl alcohol (PVA), ethylene vinyl acetate, maleic anhydride, MAP resin, etc., and any material may be used without limitation so long as it is typically useful in the art. If the amount of the compatibilizer is too low, compatibility is not sufficient, and thus layer separation between the above two materials may occur. There is no need to use an excess of the compatibilizer.

Also, the lubricant for plastics used in the present invention may enhance binding or affinity between the grassy biomass-containing mixture and the synthetic resin, and may reduce the generation of frictional heat upon mixing and extrusion and thus prevents thermal decomposition and enables efficient extrusion. Even when this component is added, mechanical properties are maintained similarly to the basic material, and efficient workability may be ensured. The lubricant may be any one or a mixture of two or more selected from the group consisting of stearates, palmitate, and laureates, which are natural materials having high eco-affinity. Preferably useful is calcium stearate, zinc stearate or a mixture thereof. If the amount of the lubricant for plastics is too low, a lubrication effect is not sufficiently exhibited upon forming a film. In contrast, if the amount thereof is excessively large, internal bonding of the film may be formed or carbides or flow marks may be generated in the forming process, undesirably deteriorating the appearance.

The mixing is performed at 70˜110° C. for 15˜35 min. If the mixing time is shorter than 15 min, it is difficult to achieve thorough mixing. In contrast, if the mixing time is longer than 35 min, oxidation occurs and yellowing may thus be caused. The forming temperature of a mixer is preferably set to a temperature lower by about 20° C. than the melting temperature of the base resin.

Thereby, the composition for a biomass film may be prepared, and is then melt-extruded using an extruder, thus forming a film. Also, this composition may be provided alone in the form of a film, thus obtaining a biomass film. In the case where this composition is used for shopping bags or fertilizer sacks, it may be formed into a monolayer film taking into consideration the eco-friendly properties. Also, this composition may be co-extruded with another plastic resin, thus forming a multilayer biomass film. Depending on the type of selected resin, films imparted with a variety of functions may be obtained. For example, a film having high gas barrier properties, a film having high thermal adhesion, etc., may be used in order to obtain predetermined functionality.

The polyolefin-based resin is preferably a PE resin. This is because the softening temperature range of PE is wider than that of PP and PE has an advantageous structure. The PE resin may be more specified to improve processability and properties so as to be used for shopping bags. The PE resin may include, based on the total weight of PE resin, 60˜80 wt % of HDPE, and 20˜40 wt % of LDPE or LLDPE. When LDPE and LLDPE are used together, LDPE may be used in an amount of 15˜25 wt %, and LLDPE may be used in an amount of 75˜85 wt %, based on the weight thereof.

The biomass film may be manufactured from only the composition for a biomass film. Also, in the case where the biomass film is co-extruded in a monolayer form, EVA or SEBS resin may be added depending on the amount of wheat bran or soybean hull, thus enhancing elongation and tensile strength. In the case of EVA resin, EVA containing 12˜21% of vinyl acetate is preferably used, and the amount thereof is set to 0.6˜5 wt %, based on the total weight of the film. If the amount of the EVA resin is too low, changes in properties cannot be confirmed. In many cases, the discharge part of the dice may become viscous upon extrusion, so that the internal pressure of the cylinder may increase, thus generating natural heat and carbonizing the biomass, making it impossible to perform continuous film formation. For the same reason, SEBS has high adhesion, and is appropriately used in an amount of 2˜10 wt %, based on the total weight of the film.

In the case of the biomass film, the useful resin preferably has high flowability and low-temperature forming grade. When a general-grade resin is used, it may be mixed with a low-temperature forming grade resin. The temperature of the cylinder is preferably set to be lower by about 5˜15% than a typical temperature. This is because the natural material is contained, and thus flowability is lowered, and the coefficient of friction may increase, thus generating natural heat, compared to the general resin. Hence, energy saving effects may be obtained upon preparation of the biomass film.

A better understanding of the present invention may be obtained through preferred examples. The following examples and test examples are set forth to illustrate, but are not to be construed as limiting the present invention.

### EXAMPLE 1

### Preparation of Mixture Containing Grassy Agricultural Waste 1

Wheat bran was dried to a moisture content of 5%, primarily pulverized using a ball mill, and passed through a 150˜200 mesh, and the resulting powder was further pulverized using an air jet mill (Micro-Jet Mill System, available from HANKOOK PULVERIZING MACHINERY Co., LTD.). 100 parts by weight of the prepared wheat bran powder, 15 parts by weight of calcium carbonate including 10% calcium carbonate with a size of 100 nm based on 100% calcium carbonate, 1 part by weight of calcium stearate, and 5 parts by weight of TEG were kneaded at a high speed while being gradually heated from 80° C. to 110° C. for 15 min, thus preparing an impregnated porous grassy agricultural waste (biomass).

### EXAMPLE 2

### Preparation of Mixture Containing Grassy Agricultural Waste 2

A porous grassy biomass was prepared in the same manner as in Example 1, with the exception that 5 parts by weight of carrageenan was further added.

### EXAMPLES 3 AND 4

### Preparation of Composition for Biomass Film

100 parts by weight of LLDPE, 120 parts by weight of the impregnated porous grassy biomass of Example 1, 5 parts by weight of glycidyl methacrylate, and 5 parts by weight of calcium stearate were mixed using a mixer at 80˜110° C. for 25 min (Example 3). In addition, the mixture containing the red alga extract of Example 2 was used thus preparing a composition (Example 4).

### EXAMPLES 5 AND 6

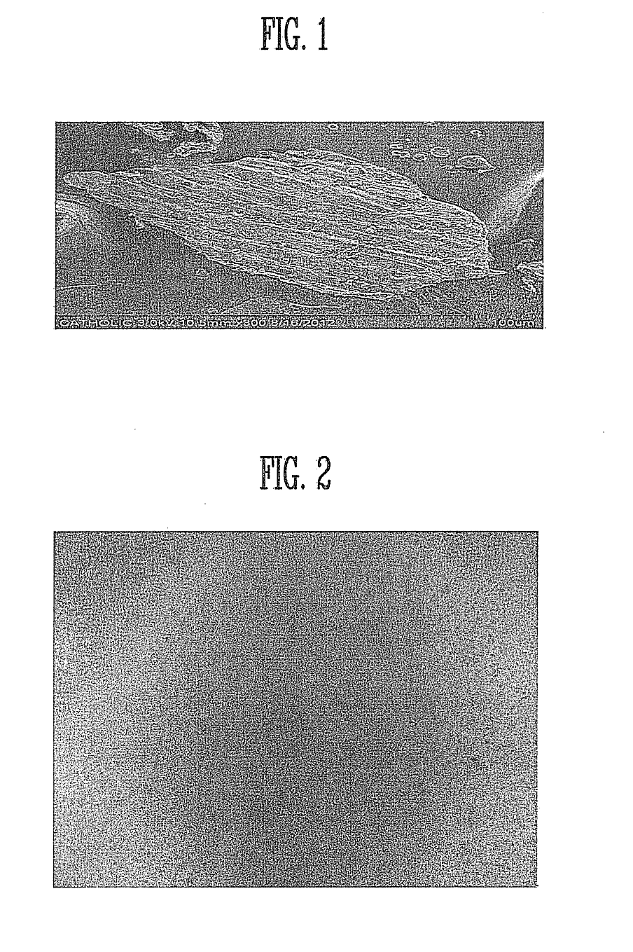

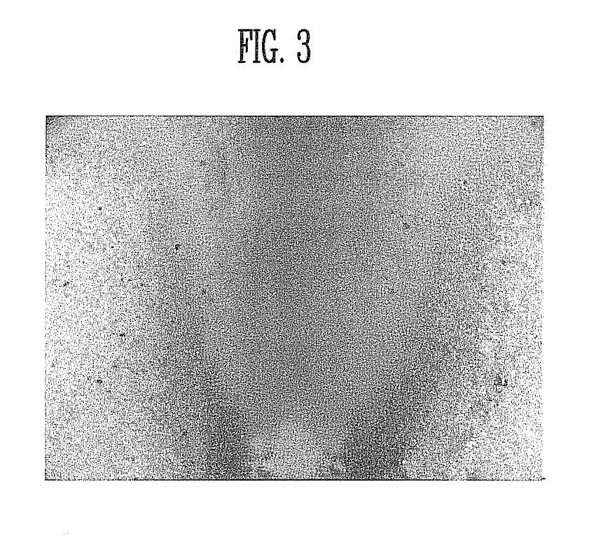

The composition for a biomass film of Examples 3 and 4 was extruded, thus manufacturing a biomass film. As seen in FIG. 2, the wheat bran was dispersed in the film.

### EXAMPLE 7

The resin mixture of Example 3 was further mixed with 10 parts by weight of SEBS, thus preparing a composition, which was then manufactured into a biomass film.

### COMPARATIVE EXAMPLE 1

The wheat bran powder of Example 1 was used as a biomass material, and the composition for a biomass film was prepared in the same manner as in Example 3, and thus a biomass film was manufactured using a typical process (Comparative Example 1). The thickness of this film was set to be the same as in the other examples. Also, the film was compared with a commercially available LLDPE based shopping bag.

### Properties

According to ASTM D 3826, the formed film samples were measured in terms of tensile strength, tear strength, and elongation. The film of Example 5 was slightly poor but was appropriate for use in shopping bags. When comparing with Example 5, Examples 6 and 7 were comparatively superior in terms of tensile strength and elongation. Despite containing the biomass component, there was no great difference from the properties of a conventional polyolefin-based film. In Comparative Example 1, it was not easy to increase the temperature in the process of mixing the composition for a biomass film, and kneading was not efficiently performed. Also, during extrusion, carbonization occurred partially, flowability was poor, and surface roughness of the film was bad, and thus the film of Comparative Example 1 was evaluated to be inappropriate for use in a film.

### Evaluation of Photodegradability

According to ASTM D15 UV treatment, UV light was radiated onto the film using a UV treatment tester for 200 hr, after which changes in the tensile strength and elongation of the film were measured. The light dose was 0.60 w/nf (310 nm).

In Example 5, tensile strength was remarkably decreased to 5% or less, and elongation was also considerably lowered. In Examples 6 and 7, strength and elongation retentions were lowered to ⅓ of those of a typical film for shopping bags. The degradability of the biomass film of the invention was evaluated to be superior.

### Evaluation

Taking into consideration the overall properties and degradability, the films of the examples are evaluated to be suitable for use in shopping bags. Depending on the weight of packaging objects and the required properties of the end uses, the embodied forms and amounts of the examples are considered to be appropriately controllable.

As described hereinbefore, the present invention provides a composition for a biomass film, which is adapted to be processed to a film despite using a biomass material. The composition for a biomass film has properties suitable for use in films for shopping bags and general industrial packaging. Also, because the amount of the biomass used is not low within a range which satisfies the properties of a film for shopping bags, the biomass film of the invention has high biodegradability and is thus very eco-friendly. The film of the invention is reproducible and recyclable.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A composition for a biomass film, comprising:
100 parts by weight of a polyolefin-based resin, 50˜150 parts by weight of a powdery porous grassy biomass comprising one or more selected from the group consisting of wheat bran and soybean hull, 5˜20 parts by weight of an inorganic filler, 0.5˜3 parts by weight of a surface coating agent, and 1˜10 parts by weight of a liquid low-molecular-weight compound.

2. The composition of claim 1, wherein pores of the powdery porous grassy biomass are impregnated with the inorganic filler and the liquid low-molecular-weight compound.

3. The composition of claim 2, further comprising 1˜10 parts by weight of a compatibilizer and 1˜10 parts by weight of a lubricant for plastics, in order to improve miscibility of the polyolefin-based resin and the powdery porous grassy biomass.

4. The composition of claim 1, wherein the polyolefin-based resin is PE.

5. The composition of claim 1, wherein the liquid low-molecular-weight compound is one or more selected from the group consisting of MEG, DEG, TEG, and PEG.

6. The composition of claim 4, wherein the PE resin comprises HDPE and at least one of LDPE, LLDPE or a combination thereof,
wherein the HDPE is used in an amount of 60˜80 wt %, and at least one of the LDPE, the LLDPE or the combination thereof are used in an amount of 20˜40 wt %, based on a total weight of the PE resin.

7. The composition of claim 4, wherein the PE resin comprises HDPE, LDPE and LLDPE,
wherein the HDPE is used in an amount of 60˜80 wt %, and the LDPE and the LLDPE are used in an amount of 20˜40 wt %, based on a total weight of the PE resin,
wherein the LDPE is used in an amount of 15˜25 wt %, and the LLDPE is used in an amount of 75˜85 wt %, based on a total weight of the LDPE and the LLDPE.

8. The composition of claim 4, wherein the PE resin comprises at least one of LDPE, LLDPE or a combination thereof.

9. The composition of claim 1, wherein the powdery porous grassy biomass is processed from wheat bran.

10. A biomass film, composed mainly of the composition of claim 1 and being reproducible and recyclable.

11. A method of manufacturing a biomass film which is reproducible and recyclable, comprising:
i) mixing a powdery porous grassy biomass comprising one or more selected from the group consisting of wheat bran and soybean hull, an inorganic filler, a surface coating agent, and a liquid low-molecular-weight compound, and heating them while being kneaded at a high speed, thus obtaining a mixture;
ii) heating the mixture obtained in i), a polyolefin-based resin, a compatibilizer, and a lubricant for plastics while being mixed together, thus obtaining a mixed composition; and
iii) extruding the mixed composition, thus forming a film.

12. The method of claim 11, wherein the composition comprises 100 parts by weight of the polyolefin-based resin, 50˜150 parts by weight of the porous grassy biomass, 5˜20 parts by weight of the inorganic filler, 0.5˜3 parts by weight of the surface coating agent, 1˜10 parts by weight of the liquid low-molecular-weight compound, 1˜10 parts by weight of the compatibilizer, and 1˜10 parts by weight of the lubricant for plastics.

13. The method of claim 11, wherein the heating is performed at 70˜110° C.

14. The method of claim 11, wherein the extruding is performed by additionally using a resin selected from the group consisting of EVA and SEBS so as to enhance elongation and tensile strength.

15. The method of claim 12, where the heating is performed at 70˜110° C.
